(19) United States
(12) Patent Application Publication
(10) Pub. No.: US 2012/0066117 A1
(43) Pub. Date: Mar. 15, 2012

(54) SYSTEM AND METHOD FOR IMPROVED FINANCIAL CONTRIBUTIONS MADE BY A PLURALITY OF FANS TO A PLURALITY OF COLLEGES

(76) Inventor: Karl J. Shuman, Melbourne, FL (US)

(21) Appl. No.: 13/225,742

(22) Filed: Sep. 6, 2011

Related U.S. Application Data
(60) Provisional application No. 61/380,531, filed on Sep. 7, 2010.

(51) Int. Cl. G06Q 50/20; G06Q 40/00

(52) U.S. Cl. 705/39; 705/326

(57) ABSTRACT

A system and method for enhancing financial contributions made by a plurality of fans to a plurality of colleges comprising a plurality of college-based websites; a financial contribution database; a sports team results database; a processing unit and a master program website

### CROSS-REFERENCE TO RELATED APPLICATION

This application claims the benefit of provisional application No. 61/380,531, filed Sep. 7, 2010, the entire contents of which are incorporated by reference herein.

### TECHNICAL FIELD

This disclosure relates to a system and method to improve financial contributions made by a plurality of fans to a plurality of colleges. More specifically, this disclosure relates to a method and system for tying financial contributions to college sports teams' achievements, aggregating those results and displaying them for competitive purposes.

### BACKGROUND OF THE INVENTION

College athletics is a highly competitive and profitable industry. One need look no further than the nearest water cooler to find passionate and heated debate concerning the previous weekend's football games. Friendships have been made and broken based on allegiances to various athletic institutions. Proposals have been made and accepted in the spotlight of the jumbotron. But sadly, alumni fundraising has not quite reached this same level.

Currently, colleges and other institutions rely upon funds contributed by donors. Typically, donors make pledges in response to specific, timed solicitations by the institutions. This method neither capitalizes on the highly competitive instincts of those donors nor gives the colleges' fans the ability to automatically link the timing and amount of their financial contributions to the colleges based upon the achievements of the colleges' sports teams.

Hence, there exists a need in the industry to overcome these problems and provide a method and system for improving financial contributions to a plurality of institutions. Additionally, there exists a need in the industry to capitalize on the competitive spirit of college sports and tie that spirit to needed fundraising activities to benefit those same colleges.

### SUMMARY OF THE INVENTION

According to one embodiment of the present disclosure, a system for enhancing financial contributions made by a plurality of fans to a plurality of colleges is disclosed. In one aspect, a plurality of fans pledges financial contributions based upon the performance of a recipient-college's sports team's performance. In another aspect, aggregate data across a plurality of colleges is presented to permit ranking and other competitive type displays of the fundraising and college sports teams performance.

An advantage of one embodiment of the disclosure may be enhanced fundraising for the participating institutions.

Another advantage of one embodiment of the disclosure may be use of the college sport's teams competitive spirit as a means of encouraging further and more substantial contributions to the participating institutions.

Another advantage of one embodiment of the disclosure may be tying fundraising activities and amounts to athletic team performance and results.

Various embodiments of the disclosure may have none, some, or all of these advantages. Other technical advantages of the present disclosure may also be readily apparent to one skilled in the art.

### BRIEF DESCRIPTION OF THE DRAWINGS

For a more complete understanding of the present disclosure and its advantages, reference is now made to the following descriptions, taken in conjunction with the associated drawings, in which:

FIG. 1 depicts a model of the system in accordance with the present disclosure.

FIG. 2 depicts a flow chart illustrating one embodiment of a series of steps that may be performed in accordance with the teachings of the present disclosure.

### DETAILED DESCRIPTION OF THE DRAWINGS

The disclosed system relates to a system 10 and method for enhancing financial contributions made by a plurality of fans 16 to a plurality of colleges 14. In a preferred embodiment, the system 10 comprises a plurality of college-based websites 12, a financial contribution database 18, a sports team results database 20, a processing unit 22, and a master program website 24.

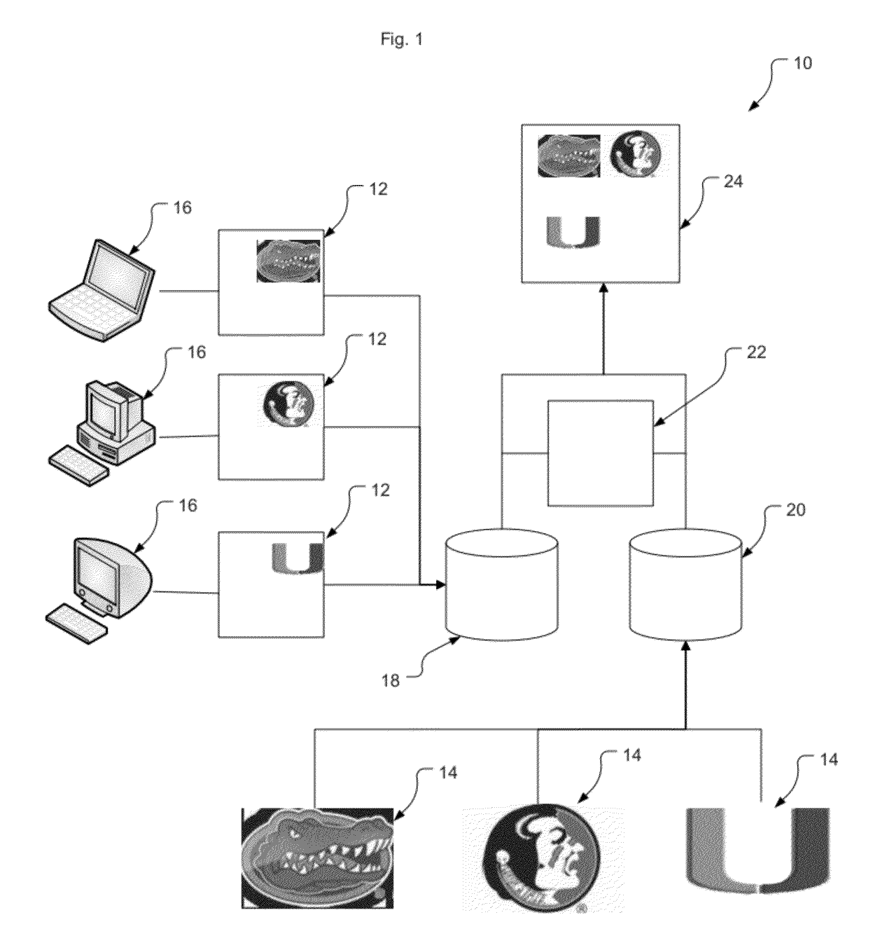

As depicted in FIG. 1, a plurality of fans 16 preferably interact with the system 10 via a plurality of college-based websites 12. The fans 16 generally would have some allegiance or other affinity to a particular college 14 (although that is not necessary). Through the college-based websites 12, the fans 16 would be permitted to register an account (which may include some personal information, such as name, address, class year (if any), email address, telephone number, and the like). The fan 16 also may register payment information (such as credit card, debit card, PayPal, banking ECH, or other similar type information) so that the system 10 may transfer the pledged amount to the college 14 (discussed below). During registration (or at any other time) a fan 16 also may indicate which of the college's 14 sports teams the fan wishes to support.

A college 14 that wishes to participate in this system 10 may identify which of its sports teams are involved in the system 10. Thus, a college 14 may have some teams that participate in the system 10, while other do not. When a fan 16 wishes to register a desire to support a particular team, the team will be presented as an option only if the college 14 has indicated it is available.

When the fan 16 selects one or more sports teams to support, the fan 16 may enter an appropriate contribution formula or program. A contribution formula or program is a formula that determines the amount of a fan's 16 contribution based upon the performance of a sports team of the college 14. For instance, the contribution formula may be based upon the number of games won by a team, home runs hit by the baseball team, touchdowns scored by the football team, goals scored by the hockey team, three-point baskets scored by the basketball team, etc. The system 10 may present pre-selected contribution formulae to the fan 16 (i.e. “$1.00 for every touchdown”) or the fan 16 may create her own formula.

Throughout the season, fans 16 may adjust their contribution formula or amount. Fans 16 may add additional teams to base their contributions on, or remove teams that the fan is currently basing contributions on.

Returning to FIG. 1, the system 10 further comprises a financial contribution database 18. The financial contribution database preferably may be used to store information pertaining to the donations pledged by the fans 16. The financial contribution database may also be used to store payment information pertaining to each fan (i.e. credit card, debit card, PayPal, etc.)

The sports team results database 20 is utilized to store various types of sports related statistics. These sports related statistics could include any statistics about any sporting event related to the college 14 and is used by the system 10 to calculate each fan's 16 donation amount based upon the contribution formula associated with the fan's 16 commitment. Thus, the sports team results database 20 may include win-loss information, number of yards obtained, first downs, field goals, touchdowns, home runs, walks, stolen bases, power play minutes, etc.

The financial contribution database 18 and sports team results database 20 may be centrally located in a single location or remotely located from one another. Preferably, the financial contribution database 18 and sports team results database 20 are relational databases, but could be any system or structure for storing and retrieving data. Similarly, the financial contribution database 18 and sports team results database 20 may be contained in a single database, or may be separate databases.

The system 10 also comprises a processing unit 22. The processing unit 22 can be any computer processing unit, and could be a single central processing unit, or a number of processing units configured to operate either in sequence or in parallel. The processing device can be configured to execute software processes which implement the steps disclosed herein. The system also may include a memory capable of storing the steps necessary for a processing device to implement the steps disclosed herein. This memory could be in the form of memory resident within the processing device or in the form of standalone memory coupled to the processing unit via a communication path, such as a bus or a network.

The processing unit 22 may be communicatively coupled to the financial contribution database 18 and sports team results database 20. In a preferred embodiment, after a sporting event, the sports team results database 20 is updated with new values reflecting collected statistics for the sporting event. The processing unit 22 then preferably gathers the statistics stored in the sports team results database 20, gathers the contribution formulas for each fan 16 stored in the financial contribution database 18 and then calculates an appropriate donation amount for each fan 16. The processing unit 22 may then store the determined financial contribution amount (for instance in the financial contribution database) or may pass the information along for immediate processing. (As discussed below, in a preferred embodiment, processing is deferred and performed on a periodic basis.)

The below discussion presents some exemplary calculations that may be performed by the processing unit 22 to determine appropriate contribution amounts.

(1) Contribution for a “Win”

For a contribution formula based upon a win, for each game in which the fan's 16 sports teams participated, the processing unit 22 calculates the amount of the financial contributions being made by each fan 16 for each game by each of the college's 14 sports teams participating in the fan's 16 contribution programs. By way of illustration, but not limitation, in one embodiment, if a fan 16 has elected to contribute fifty ($0.50) cents for each game won by a college's 14 sports teams participating in that college's 14 contribution program, then after the sports team results database 20 has been updated (or at any other time specified by the system 10) the processing unit 22 would calculate fifty cents per each win and store the result in the financial contribution database 18.

(2) Contributions for User's Basketball Team

If a fan 16 has elected to contribute ten ($0.10) cents for each three-point basket scored by a college's 14 basketball team, then, upon the conclusion of a basketball game and the storage of statistics in the sports team results database 20 the processing unit 22, will calculate the correct donation amount. So, if the basketball team scored five three-pointers, and the fan 16 pledged ten cents for each three-pointer, the financial contribution database 18 will be updated to indicate the fan's 16 donation of fifty cents (5×$0.10).

(3) Contributions for Baseball Team

If a fan 16 has elected to contribute twenty-five ($0.25) cents for each home run, then the system 10 will multiply the number of home runs by the pledged amount ($0.25) and store that information in the financial contribution database 18 as well.

(4) Contributions for Hockey Team

Similarly, a fan 16 can pledge donations based upon the number of goals scored by the college's 14 hockey team, for instance.

(5) Contributions for Football Team

Similarly, a fan 16 can pledge donations based upon the number of touchdowns scored by the college's 14 football team, for instance.

A fan 16 may also combine a number of criteria in forming a contribution formula. For example, if a fan 16 has elected to contribute both (1) twenty-five ($0.25) cents for each game won by a college's 14 basketball team, and (2) ten ($0.10) cents for each three-point basket scored, then the system 10 can perform the appropriate calculation at the conclusion of the sporting event. Thus, if the basketball team wins and scores five three-pointers, the system 10 would calculate a donation amount of $0.75 ($0.25+(5×$0.10)). Alternatively, if the team loses but still scores the five three-pointers, the system 10 would calculate a donation amount of $0.50 (5×$0.10)

A fan's 16 combination of a number of criteria need not be limited to a single sporting event. For instance, a fan's 16 donation may be based upon the number of three-pointers made in a basketball game and goals scored in a hockey game.

Returning to FIG. 1, the system 10 further comprises a master program website 24. Preferably, the master program website 24 may be used to display competitive information related to all participating colleges 14 in the system 10. Thus, if one college's 14 fans' 16 donations have generated a lot of money, the college 14 may be ranked higher on the master program website 24. In turn, this may drive fans 16 of a competing college 14 to alter their contribution formulas and in turn may drive more donations to the college 14.

The system 10 preferably may be implemented in a computing system, which can include a personal computer, a workstation, a network computer, a hand held computer, or any other computing system. Further, the system can be written as a software program in any appropriate computer language.

The processing unit 22 (or another processing component, not depicted) may then present the appropriate donation amount to a financial institution for processing. In a preferred embodiment, the financial institution processing will be done on a periodic basis (such as monthly) in order to limit the transaction costs. Thus, the processing unit 22 may gather all donation amounts from the financial contribution database 16 and then, based upon the payment instructions each fan 16 has registered with their account, perform the appropriate financial transaction to transfer the proper amount from the fan 16 to the college 14. The system 10 may also generate receipts and provide these receipts to the fan 16 to be used for tax or other purposes.

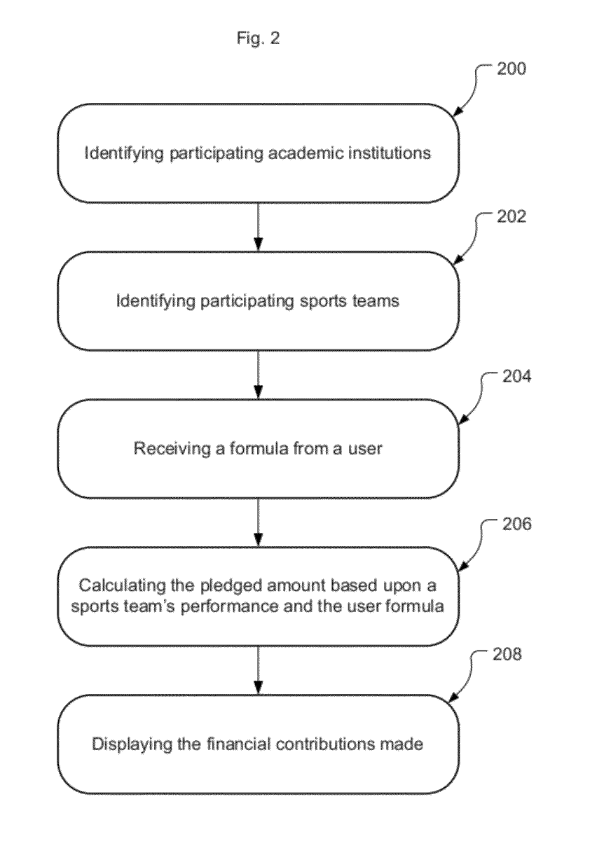

FIG. 2 depicts a flow chart illustrating steps that may be performed in accordance with the present disclosure. The method begins at step 200 by identifying academic institutions (or colleges 14) which wish to participate in the system. Next, for each academic institution identified, the sports teams that the academic institution wishes to associate with the method are identified at step 202.

Next, in step 204, a formula is received from the user. The formula is a formula used for determining contribution amount as discussed in detail above. In step 206, after the respective sports event has occurred, the pledged amount is calculated based upon the sports team's performance and the user's formula. Notably, the method (and system 10 above) may also be performed during the respective sports events for real-time processing.

Returning to FIG. 2, the method continues at step 208 by displaying the financial contributions made to each of the participating academic institutions.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for enhancing financial contributions made by a plurality of fans to a plurality of colleges, the system comprising:
a plurality of college-based websites, each college-based website associated with a college and designed to receive donations from a plurality of fans wherein the plurality of fans each pledge donations to the college by selecting a contribution program wherein the contribution program links a financial contribution amount to a performance achieved by the college's sports teams;
a financial contribution database wherein the donations pledged by the fans are stored in the financial contribution database;
a sports team results database wherein statistics concerning the performance of each college's sports teams are stored;
a processing unit interconnected to the financial contribution database, and the sports team results database wherein after each sports event, the processing unit calculates a financial contribution amount for each fan and stores that financial contribution amount in the financial contribution database; and
a master program website designed to enhance contributions to each college, the master program website displaying competitive information about each college's performance in the system, the competitive information comprising the number of colleges in the system, the number of fans participating, the total amount of financial contributions made to each college, and a ranking of colleges based upon the number of fans participating, and the gross amount of financial contributions.

2. A system comprising:
a plurality of websites associated with a plurality of institutions wherein each website receives pledges from a plurality of users wherein each pledge corresponds to a performance metric of the institution;
a first database for storing the pledge information;
a second database for storing the performance metrics of the institutions;
a processing unit for calculating a pledged amount for each user based upon the pledge received from the user and the corresponding performance metric of the institution; and
a centralized website for displaying aggregate information about pledges and performance metrics throughout the system.

3. The system of claim 2 wherein the institution is an academic institution.

4. The system of claim 3 wherein the academic institution is a college.

5. The system of claim 2 wherein the performance metric is associated with a sports team.

6. The system of claim 2 wherein the pledge comprises a formula for determining a dollar amount based upon the number of times the institution's sport's team scores.

7. The system of claim 6 wherein the formula comprises a dollar amount pledge for each touchdown scored by the institution's football team.

8. The system of claim 6 wherein the formula comprises a dollar amount pledge for each goal scored by the institution's hockey team.

9. The system of claim 6 wherein the formula comprises a dollar amount pledge for each win by the institution's soccer team.

10. The system of claim 6 wherein the formula comprises a dollar amount pledge for each yard gained by the institution's football team's halfback.

11. The system of claim 2 wherein the processing unit calculates the pledged amount after the performance metrics have been stored in the second database.

12. The system of claim 2 wherein the performance metric is associated with a sports team and the processing unit calculates the pledged amount after each game played by the sports team.

13. The system of claim 2 wherein the centralized website ranks the plurality of users and displays the ranking.

14. The system of claim 2 wherein the centralized website ranks the plurality of institutions and displays the rankings.

15. The system of claim 14 wherein the ranking is based upon the number of users who have pledged to the institution.

16. The system of claim 14 wherein the ranking is based upon the amount of money pledged to the institution.

17. The system of claim 2 further comprising:
a payment unit communicatively connected to the processing unit wherein the payment unit processes payment transactions corresponding to the calculated pledged amount to transfer the pledged amount from an account associated with the user to an account associated with the institution.

18. The system of claim 17 wherein the payment unit processes payment transactions once per month.

19. A method for increasing financial contributions from a plurality of users to a plurality of academic institutions, the method comprising:
identifying a plurality of academic institutions that wish to receive contributions;
for each academic institution, identifying a plurality of sports teams from which the contributions are going to be calculated;
receiving a formula from each user wherein the formula determines a pledge amount based upon a performance of the sports team;
after a sporting event, calculating the pledged amount using the formula and processing a financial transaction to transfer the calculated pledged amount to an account associated with the academic institution; and
displaying through a graphic interface information about the financial contributions made to each of the academic institutions.

20. The method of claim 19 wherein displaying through a graphic interface information about the financial contributions made to each of the academic institutions comprises ranking the academic institutions based upon their financial contribution performance and displaying the ranking.
